(19) United States
(12) Patent Application Publication
(10) Pub. No.: US 2026/0188025 A1
(43) Pub. Date: Jul. 2, 2026

(54) METHOD FOR GROUPING FACIAL FEATURE OBJECTS AND METHOD FOR OPERATING AN IN-VEHICLE SYSTEM

(71) Applicant: MiTAC Digital technology Corporation, Taoyuan City (TW)

(72) Inventor: Hsiang-Yu HSIEH, Taoyuan City (TW)

(21) Appl. No.: 19/436,281

(22) Filed: Dec. 30, 2025

(30) Foreign Application Priority Data
Jan. 2, 2025 (TW) 114100162
Sep. 30, 2025 (TW) 114137514

(51) Int. Cl. G06V 20/59; G06V 10/764; G06V 10/771; G06V 10/776; G06V 40/16

(52) U.S. Cl. CPC G06V 20/597; G06V 10/764; G06V 10/771; G06V 10/776; G06V 40/171; G06V 40/172

(57) ABSTRACT

A method for grouping facial feature objects in an image containing a number K of faces, which are respectively associated with a number K of people and each of which contains a number N of facial feature objects, includes: grouping a number (K*N) of entries of facial feature data into a number K of groups; calculating a match score that is associated with the entry of facial feature data and that indicates a probability of an entry of base facial feature data being correctly grouped for each of the number (K*N) of entries of facial feature data, which results in a number (K*N) of match scores; and implementing a re-grouping process with respect to an entry of target facial feature data that has a low match score, so as to obtain a number K of adjusted groups.

### CROSS-REFERENCE TO RELATED APPLICATION

This application claims priority to Taiwanese Invention Patent Application No. 114100162, filed on Jan. 2, 2025 and Taiwanese Invention Patent Application No. 114137514, filed on Sep. 30, 2025, the entire disclosures of which are incorporated by reference herein.

### FIELD

The disclosure relates to a method and system for grouping, and more particularly to a method and system for grouping facial feature objects.

### BACKGROUND

In the field of image recognition, facial recognition is one popular application. In one example, it may be beneficial to identifying a specific face of a target person in a two-dimensional (2D) image that includes multiple faces. It is noted that 2D images typically lack the element of depth, and as a result currently available image recognition algorithms and models may erroneously identify another face as the specific face.

In the application of a conventional in-vehicle driver monitoring system (DMS) of a vehicle, the DMS may employ an in-vehicle camera that continuously captures images of the inside of the vehicle (i.e., the vehicle interior), in order to identify the driver's face of the vehicle. By processing the images, the DMS is configured to identify the facial features of the driver, to determine whether the driver is distracted or fatigued, and to output alarm if the determination is affirmative. Nevertheless, in the cases where multiple people are in the vehicle, and the their faces are constantly moving (e.g., the front passenger seat turning to talk to the driver, or passengers in the backseats move toward the driver, etc.), the DMS may mistake the faces of others for the face of the driver, causing potential false alarms then the DMS erroneously determines the “driver” to be in a distracted state.

In order to prevent such an issue, the DMS generally implements a conventional grouping operation to group multiple facial features identified in the images by determining which facial feature(s) belong to the same person (specifically, the facial features belonging to the same person are grouped) based on distances and similarities among the facial features and/or intersection over union (IoU) ratios among the facial features. However, the conventional grouping operation is still limited by the fact that the 2D images typically lack depth information and may not be accurate when multiple faces are present. After the grouping operation is performed, the DMS may still be unable to distinguish whether the face feature belongs to the driver or a passenger located in a front row or a rear row.

### SUMMARY

Therefore, an object of the disclosure is to provide a method that can alleviate at least one of the drawbacks of the prior art.

According to one embodiment of the disclosure, the method is for grouping facial feature objects in a two-dimensional image. The image contains a number K of faces associated with a number K of people, respectively. Each of the faces containing a number N of facial feature objects, resulting in a number (K*N) of facial feature objects. The method is implemented using an electronic device that includes a data storage unit and a processing unit, the data storage unit storing a facial object detection model and a facial object prediction model therein. The method includes:
A) executing the facial object detection model to process the image to obtain a number (K*N) of entries of facial feature data, each of the number (K*N) of entries of facial feature data being associated with one of the facial feature objects included in one of the number K of faces;
B) designating, for each of the number (K*N) of facial feature objects, the facial feature object as a to-be-predicted object that is to be associated with a to-be-predicted person, designating the corresponding entry of facial feature data that corresponds to the to-be-predicted object as an entry of to-be-predicted facial feature data, and utilizing, based on the entry of to-be-predicted facial feature data, the facial object prediction model to obtain a number N of entries of predicted facial feature data that correspond respectively to a number N of predicted facial feature objects which are predicted to belong to the to-be-predicted person;
C) performing an initial grouping process to group the number (K*N) of entries of facial feature data, which correspond respectively to the number (K*N) of facial feature objects from the K people, into a number K of groups that correspond respectively to the K faces respectively of the K people;
D) designating, for each of the number (K*N) of facial feature objects, the facial feature object as a base facial feature object, designating the respective entry of facial feature data associated with the base facial feature object as an entry of base facial feature data, designating one of the K groups in which the entry of base facial feature data is grouped as a base group, and calculating a match score that is associated with the respective entry of facial feature data and that indicates a probability of the entry of base facial feature data being correctly grouped, which results in a number (K*N) of match scores; and
E) designating one of candidate entries of facial feature data that is associated with a lowest match score as an entry of target facial feature data, designating one of the facial feature objects corresponding to the entry of target facial feature data as a to-be-adjusted facial feature object, and implementing a re-grouping process with respect to the entry of target facial feature data, so as to obtain a number K of adjusted groups.

According to another embodiment of the disclosure, the method is for grouping facial feature objects in a two-dimensional image. The image containing a number K of faces associated with a number K of people, respectively. Each of the faces containing a number N of facial feature objects, resulting in a number (K*N) of facial feature objects. The method is implemented using an electronic device that includes a data storage unit and a processing unit, the data storage unit storing a facial object detection model, a facial object prediction model and a facial object grouping model therein. The method includes:
A) executing the facial object detection model to process the image to obtain a number (K*N) of entries of facial feature data, each of the number (K*N) of entries of facial feature data being associated with one of the facial feature objects included in one of the number K of faces;
B) designating, for each of the number (K*N) of facial feature objects, the facial feature object as a to-be-predicted object that is to be associated with a to-be-predicted person, designating the corresponding entry of facial feature data that corresponds to the to-be-predicted object as an entry of to-be-predicted facial feature data, and utilizing, based on the entry of to-be-predicted facial feature data, the facial object prediction model to obtain a number N of entries of predicted facial feature data that correspond respectively to a number N of predicted facial feature objects which are predicted to belong to the to-be-predicted person;
C) performing an initial grouping process to group the number (K*N) of entries of facial feature data, which correspond respectively to the number (K*N) of facial feature objects from the K people, into a number K of groups that correspond respectively to the K faces respectively of the K people;
D) designating, for each of the number (K*N) of facial feature objects, the facial feature object as a base facial feature object, designating the respective entry of facial feature data associated with the base facial feature object as an entry of base facial feature data, designating one of the K groups in which the entry of base facial feature data is grouped as a base group, and calculating a match score that is associated with the respective entry of facial feature data and that indicates a probability of the entry of base facial feature data being correctly grouped, which results in a number (K*N) of match scores;
E) designating the number (K*N) of match scores currently calculated as a current state, and using the current state as an input of the facial object grouping model to obtain a re-grouping action that is an output of the facial object grouping model; and
F) implementing a re-grouping process that includes the re-grouping action, so as to obtain a number K of adjusted groups.

Another object of the disclosure is to provide a method for operating an in-vehicle monitoring system that incorporates the above-mentioned method.

According to one embodiment of the disclosure, the method is for operating an in-vehicle monitoring system. The method is implemented by the in-vehicle monitoring system that is installed in a vehicle with a number K of people, The in-vehicle monitoring system includes an in-vehicle camera that is for capturing images of passengers in the vehicle, a non-transitory data storage medium that stores a facial object detection model, a facial object prediction model and a grouping dataset therein, and an alert unit that is connected to a processing unit. The grouping dataset includes a number (K*N) of entries of facial feature data that correspond respectively to a number (K*N) of facial feature objects and that are grouped into a number K of groups, the method includes:
A) while the vehicle is being driven, executing the facial object detection model to process an image captured by the in-vehicle camera to obtain the number (K*N) of entries of facial feature data, each of the number (K*N) of entries of facial feature data being associated with one of the facial feature objects included in one of a number K of faces respectively of the people;
B) designating, for each of the number (K*N) of facial feature objects, the facial feature object as a to-be-predicted object that is to be associated with a to-be-predicted person, designating the corresponding entry of facial feature data that corresponds to the to-be-predicted object as an entry of to-be-predicted facial feature data, and utilizing, based on the entry of to-be-predicted facial feature data, the facial object prediction model to obtain a number N of entries of predicted facial feature data that correspond respectively to a number N of predicted facial feature objects which are predicted to belong to the to-be-predicted person;
C) using the grouping dataset to group the number (K*N) of entries of facial feature data, which correspond respectively to the number (K*N) of facial feature objects from the K people, into a number K of groups that correspond respectively to the faces respectively of the K people;
D) designating, for each of the number (K*N) of facial feature objects, the facial feature object as a base facial feature object, designating the respective entry of facial feature data associated with the base facial feature object as an entry of base facial feature data, designating one of the K groups in which the entry of base facial feature data is grouped as a base group, and calculating a match score that is associated with the respective entry of facial feature data and that indicates a probability of the entry of base facial feature data being correctly grouped, which results in a number (K*N) of match scores; and
E) in a case where one of the number (K*N) of match scores is lower than a predetermined threshold, disabling the alert unit from outputting an alert.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating components of a system for grouping facial features according to one embodiment of the disclosure.

FIG. 2 is a flow chart illustrating steps of a method for grouping facial feature objects according to one embodiment of the disclosure.

FIG. 3 is a flow chart illustrating sub-steps of an initial grouping process according to one embodiment of the disclosure.

FIG. 4 is a flow chart illustrating sub-steps of calculating a match score for each entry of facial feature data according to one embodiment of the disclosure.

FIG. 5 is a flow chart illustrating sub-steps of a re-grouping process according to one embodiment of the disclosure.

FIG. 6 is a flow chart illustrating steps of a method for grouping facial feature objects according to another embodiment of the disclosure.

FIG. 7 is a flow chart illustrating steps of a training process for training a facial object grouping model according to one embodiment of the disclosure.

FIG. 8 illustrates a deviance matrix for one person, which contains all deviance values.

FIGS. 9 to 12 illustrates one example of a number of iterations of swapping operations.

FIG. 13 illustrates an exemplary image inside a vehicle with multiple faces.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

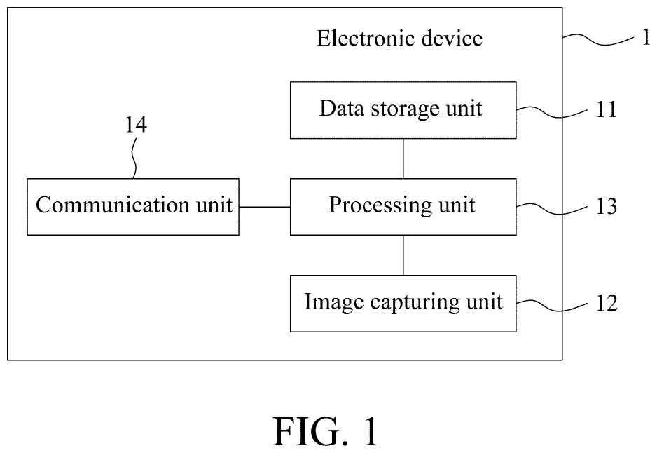

FIG. 1 is a block diagram illustrating components of a system for grouping facial features according to one embodiment of the disclosure. In the embodiment of FIG. 1, the system may be embodied using an electronic device 1 included in a driver monitoring system (DMS) installed in a vehicle (not shown). The vehicle is, for example, an automobile. The electronic device 1 includes a data storage unit 11, an image capturing unit 12 and a processing unit 13 electrically coupled to the data storage unit 11 and the image capturing unit 12.

The data storage unit 11 may be embodied using, for example, random access memory (RAM), read only memory (ROM), programmable ROM (PROM), firmware, flash memory. The data storage unit 11 stores a software program, a facial object detection model and a facial object prediction model therein. In some embodiments, the facial object prediction model may be embodied using a multilayer perceptron (MLP) neural network that employs a rectified linear unit (ReLU) as an activation function, or other suitable neural networks. The software program, when executed by the processing unit 13, causes the processing unit 13 to perform the method for grouping facial feature objects as described in the present disclosure.

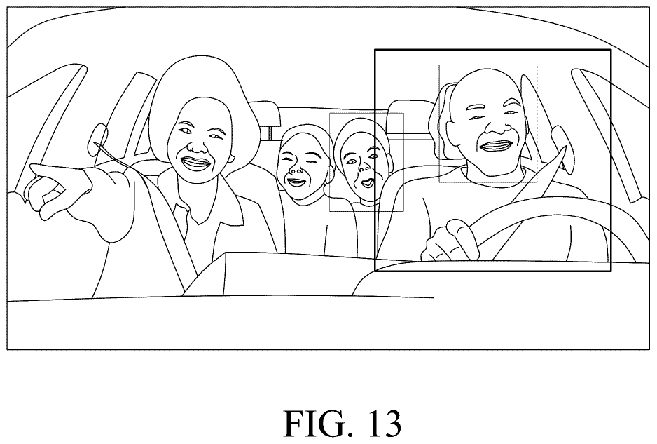

Generally, the facial object detection model may be embodied using commercially available neural networks designed for facial objection, such as a convolutional neural network (CNN), different versions of You Only Look Once (YOLO), or other suitable neural networks. The facial objection detection model is configured to, in response to receipt of an input image that contains a plurality of faces as an input, obtain, for each of the faces, a plurality of entries of facial feature data that are related to a plurality of facial feature objects on the face, respectively. The facial object prediction model is configured to predict a group of entries of predicted facial feature data that are predicted to belong to the same face based on an entry of facial feature data. In some embodiments, the number of faces in the input image is designated as K, and the number of facial feature objects on each of the faces is designated as N. As such, the facial object detection model obtains a number (K*N) of entries of facial feature data corresponding respectively to a number (K*N) of facial feature objects in total. FIG. 13 illustrates an exemplary image inside a vehicle with multiple faces.

The software program includes instructions that, when executed by a processor (e.g., the processing unit 13), cause the processor to implement operations as described below.

The image capturing unit 12 may include one or more cameras installed on different parts of the vehicle, and when activated, is configured to continuously capture images inside the vehicle. It is noted that in embodiments, the images captured by the image capturing unit 12 are two-dimensional (2D) images. FIG. 13 illustrates an exemplary image inside a vehicle with multiple faces.

The processing unit 13 is connected to the data storage unit 11 and the image capturing unit 12, and may be embodied using one or more of a central processing unit (CPU), a microprocessor, a microcontroller, a single core processor, a multi-core processor, a dual-core mobile processor, a digital signal processor (DSP), a field-programmable gate array (FPGA), an application specific integrated circuit (ASIC), a radio-frequency integrated circuit (RFIC), etc.

During use, while the vehicle is being driven, the DMS is activated, the image capturing unit 12 starts capturing images, and the processing unit 13 processes the images captured by the image capturing unit 12. In some embodiments, a plurality of people (e.g., a number K of people) are in the vehicle, and in each of the images, a number K of faces are included.

Specifically, the processing unit 13 processes the images to obtain a plurality of facial feature objects, and implements a grouping operation to group each of the facial feature objects into one of the number K of groups. That is to say, the processing unit 13 is configured to obtain a number K of groups each belonging to one of the K people included in the images.

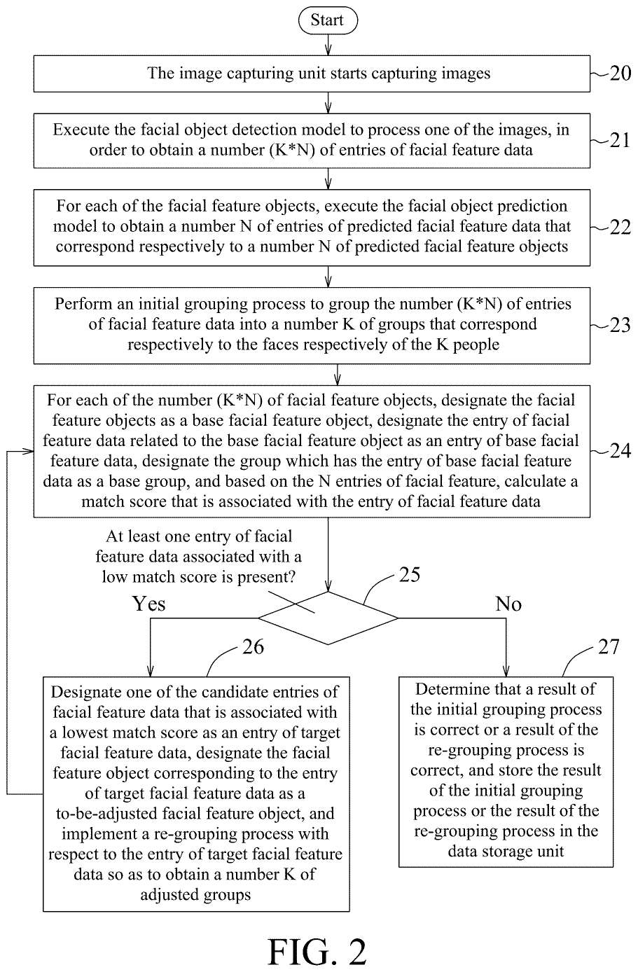

FIG. 2 is a flow chart illustrating steps of a method 200 for grouping facial feature objects according to one embodiment of the disclosure. In the embodiment of FIG. 2, the method 200 is implemented using the system of FIG. 1 or other suitable electronic devices.

In step 20, the image capturing unit 12 starts capturing images. For example, the number K of people are captured, and therefore, each of the images captured by the image capturing unit 12 includes K faces.

In step 21, the processing unit 13 executes the facial object detection model to process an image (hereinafter referred to as a processing image), in order to obtain a number (K*N) of entries of facial feature data. That is to say, for each of the faces in the processing image, a number N of entries of facial feature data that are related respectively to a number N of facial feature objects on the face are obtained. In some embodiments, each of the facial feature objects has a unique feature type, which may be one of the nose, the left eye, the right eye, the human face, the left ear, the right ear and the mouth, and the number N equals 7; that is, the number N of facial feature objects correspond to a number N of feature types, respectively. It is noted that in other embodiments, additional facial feature objects may be involved and the number N may be different. Each of the number (K*N) of entries of facial feature data is associated with one of the facial feature objects of K faces.

In this embodiment, each of the number (K*N) of entries of facial feature data includes a first coordinate value of the corresponding facial feature object with respect to a first axis (e.g., a horizontal axis or an X axis) of a 2D coordinate system of the processing image, a second coordinate value of the corresponding facial feature object with respect to a second axis (e.g., a vertical axis or a Y axis) of the 2D coordinate system, a width of the corresponding facial feature object in the processing image, a height of the corresponding facial feature object in the processing image (i.e., a distance between the lowest and highest points of the corresponding facial feature object), a first ratio of an area of the corresponding facial feature object in the processing image to an area of the nose in the processing image, a second ratio of the area of the corresponding facial feature object in the processing image to an area of the left eye in the processing image, a third ratio of the area of the corresponding facial feature object in the processing image to an area of the right eye in the processing image, a fourth ratio of the area of the corresponding facial feature object in the processing image to an area of the face in the processing image, a fifth ratio of the area of the corresponding facial feature object in the processing image to an area of the left ear in the processing image, a sixth ratio of the area of the corresponding facial feature object in the processing image to an area of the right ear in the processing image, a seventh ratio of the area of the corresponding facial feature object in the processing image to an area of the mouth in the processing image, and a label value indicating the unique feature type of the corresponding facial feature object. As such, each of the number (K*N) of entries of facial feature data may be represented by a vector including the above-mentioned twelve values. The dimension of the vector may vary depending on the value of N.

It is noted that the height and the width of each of the facial feature objects may be obtained by first obtaining a location of a corresponding bounding box for the facial feature object, and using a number of sets of coordinates that define the corresponding bounding box to obtain the width and height. Then, with the height and the width of each of the facial feature objects (i.e., the height and the width of the corresponding bounding box), the area of the facial feature object may be calculated. As such, for each of the faces in the processing image, relevant information of each of the facial feature objects may be described by one of the number (K*N) of entries of facial feature data.

In step 22, for each of the facial feature objects (i.e., for each of the number (N*K) of facial feature objects), the processing unit 13 designates the facial feature object as a to-be-predicted object which is to be associated with a to-be-predicted person, and designates the corresponding entry of facial feature data that corresponds to the to-be-predicted object as an entry of to-be-predicted facial feature data. Then, based on the entries of to-be-predicted facial feature data, the processing unit 13 utilizes the facial object prediction model to obtain a number N of entries of predicted facial feature data that correspond respectively to a number N of predicted facial feature objects which are predicted to belong to the same person (the to-be-predicted person). Consequently, a total of (K*N*N) entries of predicted facial feature data are obtained. In one example of FIG. 13 where four people are present, (4*7)=28 entries of facial feature data are obtained. After the operation of step 22, (4*7*7) entries of predicted facial feature data are obtained.

Specifically, the processing unit 13 uses the vector representing the entry of to-be-predicted facial feature data as an input of the facial object prediction model. In response, the facial object prediction model is configured to, for each of the predicted facial feature objects, output a set of predicted coordinates (which may indicate a central point of the predicted facial feature object in the processing image) and predicted dimensions of the predicted facial feature object in the processing image based on the entry of to-be-predicted facial feature data including a set of real coordinates (which may indicate a central point of the corresponding facial feature object in the processing image) and real dimensions of the corresponding facial feature object in the processing image.

In one example, the to-be-predicted object is the nose of the to-be-predicted person. During use, the processing unit 13 uses the vector representing the entry of to-be-predicted facial feature data as the input of the facial object prediction model; the entry of to-be-predicted facial feature data includes a first coordinate value of the nose with respect to the first axis of the 2D coordinate system, a second coordinate value of the nose with respect to the second axis of the 2D coordinate system, a width of the nose in the processing image, a height of the nose in the processing image, a first ratio of the area of the nose in the processing image to the area of the nose in the processing image, a second ratio of the area of the nose in the processing image to the area of the left eye in the processing image, a third ratio of the area of the nose in the processing image to the area of the right eye in the processing image, a fourth ratio of the area of the nose in the processing image to the area of the face in the processing image, a fifth ratio of the area of the nose in the processing image to the area of the left ear in the processing image, a sixth ratio of the area of the nose in the processing image to the area of the right ear in the processing image, a seventh ratio of the area of the nose in the processing image to the area of the mouth in the processing image, and a label value indicating the unique feature type (i.e., the nose).

Then, for one of the predicted facial feature objects of the to-be-predicted person (e.g., the left eye of the to-be-predicted person), the facial object prediction model is configured to, based on the entry of to-be-predicted facial feature data, output a first predicted coordinate value of the left eye with respect to the first axis of the 2D coordinate system, a second predicted coordinate value of the left eye with respect to the second axis of the 2D coordinate system, an predicted width of the left eye in the processing image, an predicted height of the left eye in the processing image, a first predicted ratio of an area of the left eye in the processing image to an area of the nose in the processing image, a second predicted ratio of the area of the left eye in the processing image to an area of the left eye in the processing image, a third predicted ratio of the area of the left eye in the processing image to an area of the right eye in the processing image, a fourth predicted ratio of the area of the left eye in the processing image to an area of the face in the processing image, a fifth predicted ratio of the area of the left eye in the processing image to an area of the left ear in the processing image, a sixth predicted ratio of the area of the left eye in the processing image to an area of the right ear in the processing image, and a seventh predicted ratio of the area of the left eye in the processing image to an area of the mouth in the processing image. As such, for each of the predicted facial feature objects, the processing unit 13 may obtain a number N of entries of predicted facial feature data corresponding respectively to the number N of unique feature types, and each of the number N of entries of predicted facial feature data may be represented by a vector including the above-mentioned eleven values.

The operations of step 22 is then repeated for each of the number (N*K) of facial feature objects, resulting in a number (K*N*N) of entries of predicted facial feature data.

In step 23, the processing unit 13 performs an initial grouping process to group the number (K*N) of entries of facial feature data, which correspond respectively to the number (K*N) of facial feature objects from the K people, into a number K of groups that correspond respectively to the faces respectively of the K people. It should be noted that the number (K*N) of entries of facial feature data are obtained by the facial object detection model in step 21.

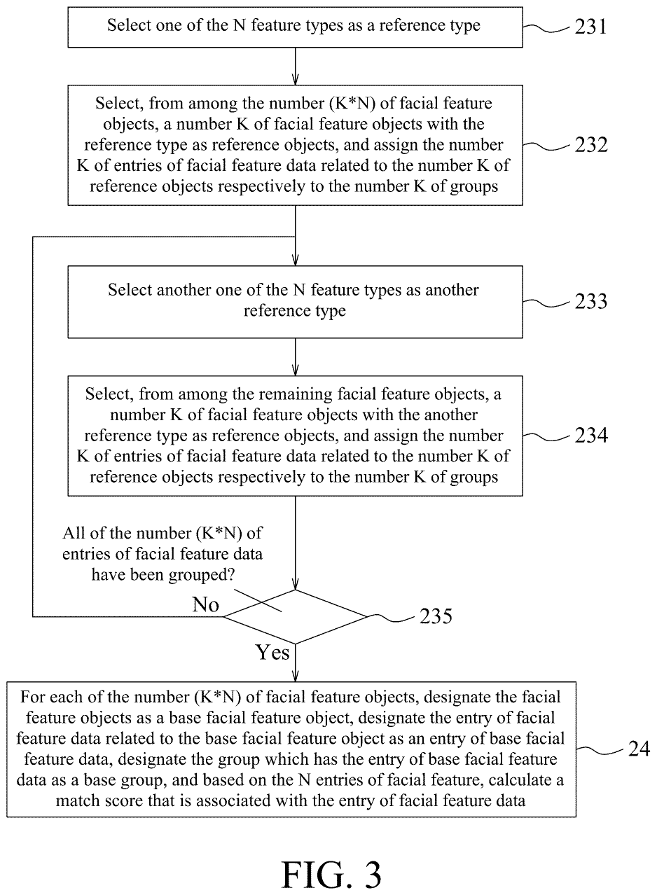

Specifically, FIG. 3 is a flow chart illustrating sub-steps of the initial grouping process of step 23 according to one embodiment of the disclosure.

In sub-step 231, the processing unit 13 selects one of the N unique feature types (i.e., the nose, the left eye, the right eye, the human face, the left ear, the right ear and the mouth) as a reference type. In one example, the reference type may be “nose.”

Then, in sub-step 232, the processing unit 13 selects, from among the number (K*N) of facial feature objects, a number K of facial feature objects with the reference type as reference objects, and assigns the number K of entries of facial feature data related to the number K of reference objects respectively to the number K of groups.

Then, in sub-step 233, the processing unit 13 selects another one of the N unique feature types (i.e., the nose, the left eye, the right eye, the human face, the left ear, the right ear and the mouth) as another reference type. In one example, the another reference type may be “left eye.”

Then, in sub-step 234, the processing unit 13 selects, from among the remaining facial feature objects, a number K of facial feature objects with the another reference type (e.g., the number K of left eyes), and assigns the number K of entries of facial feature data related to the number K of facial feature objects respectively to the number K of groups.

Specifically, the assigning of the number K of entries of facial feature data related to the number K of facial feature objects may be done by, for each of the facial feature objects, calculating a Euclidean distance between the facial feature object and each of the number K of reference objects, resulting in a number K of Euclidean distances. Then, the processing unit 13 assigns the entry of facial feature data associated with facial feature object to one of the number K of groups that results in a shortest Euclidean distance (which indicates the group that contains the reference object). In one example, with the noses grouped, the processing unit 13 processes each of the left eyes and, for each of the left eyes, assigns the left eye to one of the number K of groups that includes a nose that is the closest to the left eye.

Then, in sub-step 235, the processing unit 13 determines whether all of the number (K*N) of entries of facial feature data have been grouped. In the case where all of the number (K*N) of entries of facial feature data have been grouped, the initial grouping process is completed, and the flow proceeds to step 24. Otherwise, the flow goes back to sub-step 233, and another one of the N unique feature types (i.e., the nose, the left eye, the right eye, the human face, the left ear, the right ear and the mouth) is selected as another reference type. Then, the above process is repeated until the determination of sub-step 235 is affirmative. In one example, the initial grouping process may be implemented in an order of the nose, the left eye, the right eye, the face, the left ear, the right ear and the mouth.

At this stage, the number K of groups are created, and each of the groups is associated with one of the K people and includes the number N of entries of facial feature data.

It is noted that steps 22 and 23 are not necessarily implemented in the order as mentioned above. In some embodiments, the operations of steps 22 and 23 may be done simultaneously.

In step 24, the processing unit 13, for each of the number (K*N) of facial feature objects, designates the facial feature object as a base facial feature object i, designates the entry of facial feature data related to the base facial feature object i as an entry of base facial feature data, and designates the group which has the entry of base facial feature data as a base group. Then, based on the N entries of facial feature data that are included in the base group and the N entries of predicted facial feature data that are obtained based on the entries of base facial feature data in step 22, the processing unit 13 calculates a match score that is associated with the entry of facial feature data and that indicates a probability of the entry of base facial feature data being correctly grouped.

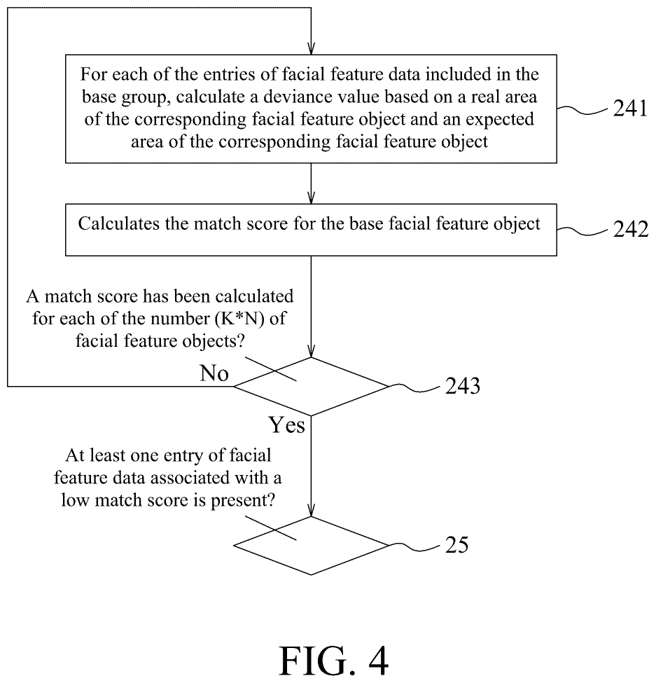

Specifically, FIG. 4 is a flow chart illustrating sub-steps of the operations of step 24 according to one embodiment of the disclosure.

In sub-step 241, for each of the entries of facial feature data included in the base group, the processing unit 13 calculates a deviance value based on a real area of the corresponding facial feature object j and a predicted area of the corresponding facial feature object j. The real area is obtained based on the entry of facial feature data related to the corresponding facial feature object j; the predicted area is obtained based on a corresponding one of the entries of predicted facial feature data that is obtained based on the entry of base facial feature data and that is related to the corresponding facial feature object j.

It is noted that the operations of step 24 are implemented for each of the number (K*N) of facial feature objects, and therefore a number (K*N) of match scores are present.

Specifically, the deviance value is calculated using the following formula:

$${D}_{\_ ij} = \vert \frac{{O}_{ij}^{base}}{{O}_{j}^{real}} - 1 \vert ,$$

where D_ᵢⱼ represents the deviance value, Oᵢⱼ^{base} represents the predicted area of the corresponding facial feature object j, and Oⱼ^{real} represents the real area of the corresponding facial feature object j. In one example, the processing unit 13 obtains an predicted ratio (i.e., one of the first predicted ratio to the seventh predicted ratio) between the base facial feature object i and the corresponding facial feature object j from the corresponding one of the entries of predicted facial feature data, which is obtained in step 22; then, the processing unit 13 calculates a product of the width and the height of the base facial feature object i included in the entry of base facial feature data, and multiplies the product by the predicted ratio to obtain the predicted area of the corresponding facial feature object j. The real area of the corresponding facial feature object j may be calculated by multiplying the width by the height of the corresponding facial feature object j included in the entry of facial feature data related to the corresponding facial feature object j.

Using the above calculation, a higher deviance value indicates that the predicted area of the corresponding facial feature object j differs more from the real area of the corresponding facial feature object j.

In one example where the base facial feature object i is the nose and the corresponding facial feature object j is the left eye, the processing unit 13 obtains the second predicted ratio indicating the ratio of the area of the nose in the processing image to the area of the left eye in the processing image. Then, the processing unit 13 obtains a real area of the left eye by multiplying the width and the height of the left eye included in the entry of facial feature data related to the left eye, and obtains an predicted area of the left eye by first calculating a product of the width and the height of the nose included in the entry of base facial feature data and multiplying the product thus calculated by the second predicted ratio. Then, the deviance value is calculated using the formula above.

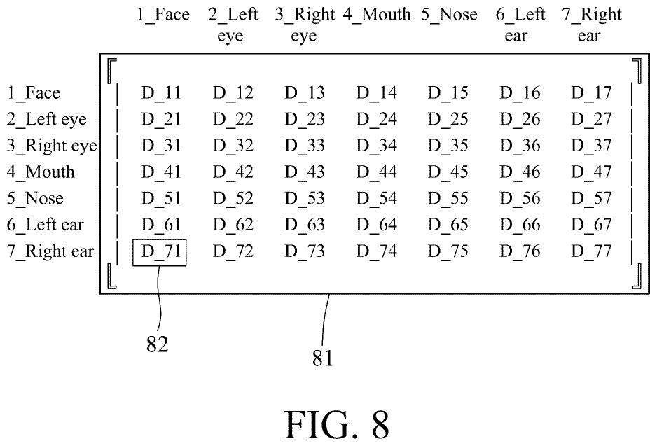

FIG. 8 illustrates a deviance matrix 81 (for one person) that contains all of the deviance values 82 calculated using the above process. Since seven facial feature objects are present in the examples, the deviance matrix 81 is in the form of a 7*7 matrix with 49 different deviance values 82. For each of the entries of facial feature data included in the base group, a number N (7) of deviance values are calculated.

Then, in sub-step 242, the processing unit 13 calculates the match score Ei for the base facial feature object i using the following formula:

$${E}_{i} = 1 - {\sum }_{j = 1}^{N} {D}_{\_ ij} .$$

It is noted that the match score associated with one base facial feature object is calculated using a corresponding one of the N deviance values D_ᵢⱼ (i.e., D_ᵢ₁ to D__{iN}).

Then, in sub-step 243, the processing unit 13 determines whether a match score has been calculated for each of the number (K*N) of facial feature objects. In the case where the match score has been calculated for each of the number (K*N) of facial feature objects, the flow proceeds to step 25. Otherwise, the flow goes back to sub-step 241, and the above process is repeated until the determination of sub-step 243 is affirmative.

In step 25, the processing unit 13 determines whether at least one entry of facial feature data associated with a low match score is present. Specifically, the low match score may be defined as a match score that is smaller than a predetermined threshold score. In the case where it is determined that one or more entries of facial feature data associated with the low match score (hereinafter referred to as “candidate entries of facial feature data”) are present, the flow proceeds to step 26. Otherwise, in the case where no entry of facial feature data associated with the low match score is present, the flow proceeds to step 27.

It is noted that the match score is calculated by subtracting the number 1 from a summation of the relevant deviance values related to the entry of base facial feature data. As such, a lower match score indicates that the relevant deviance values are relatively higher, and the corresponding facial feature object may be assigned incorrectly to one of the groups.

In some embodiments, the operations of step 25 includes the processing unit 13 using the following formula to compare the match score associated with the base facial feature object i with the predetermined threshold score:

$${E}_{i} < {e}_{th} ,$$

where eₜₕ represents the predetermined threshold score, and the match score is a low match score if the match score is lower than the predetermined threshold score.

In step 26, the processing unit 13 designates one of the candidate entries of facial feature data that is associated with a lowest match score as an entry of target facial feature data, designates the facial feature object corresponding to the entry of target facial feature data as a to-be-adjusted facial feature object, and implements a re-grouping process with respect to the entry of target facial feature data, so as to obtain a number K of adjusted groups.

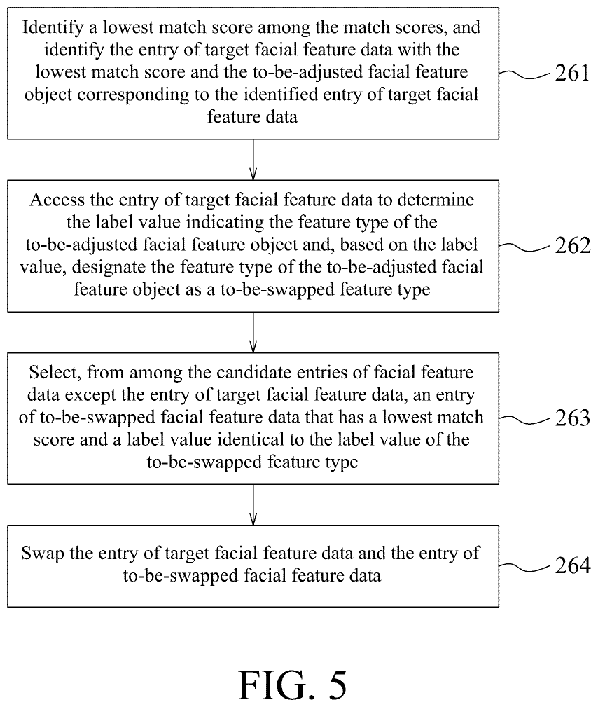

Specifically, FIG. 5 is a flow chart illustrating sub-steps of the re-grouping process of step 26 according to one embodiment of the disclosure.

In sub-step 261, the processing unit 13 employs a sorting operation to sort the match scores respectively of the candidate entries of facial feature data, identifies a lowest match score among the match scores, and identifies the entry of target facial feature data with the lowest match score and the to-be-adjusted facial feature object corresponding to the identified entry of target facial feature data.

In sub-step 262, the processing unit 13 accesses the entry of target facial feature data to determine the label value indicating the unique feature type of the to-be-adjusted facial feature object. Then, based on the label value, the processing unit 13 designates the unique feature type of the to-be-adjusted facial feature object as a to-be-swapped feature type. In one example, the to-be-swapped feature type may be “nose.”

Then, in sub-step 263, the processing unit 13 selects, from among the candidate entries of facial feature data (except for the entry of target facial feature data), an entry of to-be-swapped facial feature data that has a lowest match score and a label value identical to the label value of the to-be-swapped feature type. In this manner, the entry of to-be-swapped facial feature data thus selected is most likely to be incorrectly grouped as well.

Then, in sub-step 264, the processing unit 13 swaps the entry of target facial feature data and the entry of to-be-swapped facial feature data. In one example, the entry of target facial feature data may be grouped into a first one of the number K of groups, and the entry of to-be-swapped facial feature data may be grouped into a second one of the number K of groups. After the swap, the entry of target facial feature data is now grouped into the second one of the number K of groups, and the entry of to-be-swapped facial feature data is now grouped into the first one of the number K of groups, and the other groups (i.e., the number (K−2) of groups) remain unchanged.

After the re-grouping process is completed, the flow goes back to step 24 to process the number (K*N) of facial feature objects based on a result of the re-grouping process, and to re-obtain a number (K*N) of match scores. Then, in step 25, the processing unit 13 determines whether at least one entry of facial feature data associated with a low match score is present. In the case where at least one entry of facial feature data associated with a low match score is still present, the flow proceeds to step 26 for implementing the re-grouping process again, which is also known as an iteration to reduce the number of low match scores (that is, to achieve a convergence state where no low match score is present, meaning all of the facial feature objects are correctly grouped).

In step 27, the processing unit 13 determines that a result of the initial grouping process is correct or a result of the re-grouping process is correct, and stores the result of the initial grouping process or the result of the re-grouping process into the data storage unit 11. Typically, a number of iterations are implemented before the convergence state is achieved. In one example, after two iterations of the re-grouping process, on a third iteration, the processing unit 13 determines that in step 25, no entry of facial feature data associated with a low match score is present based on the result of the second implementation of the re-grouping process. Then, the processing unit 13 determines that a result of the re-grouping process is correct, and stores the result of the re-grouping process into the data storage unit 11.

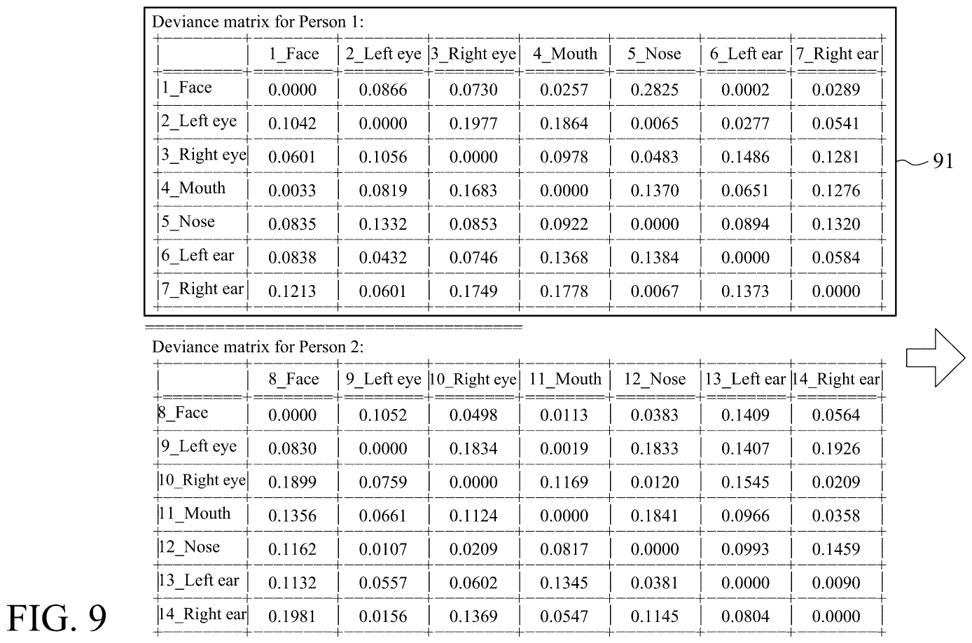

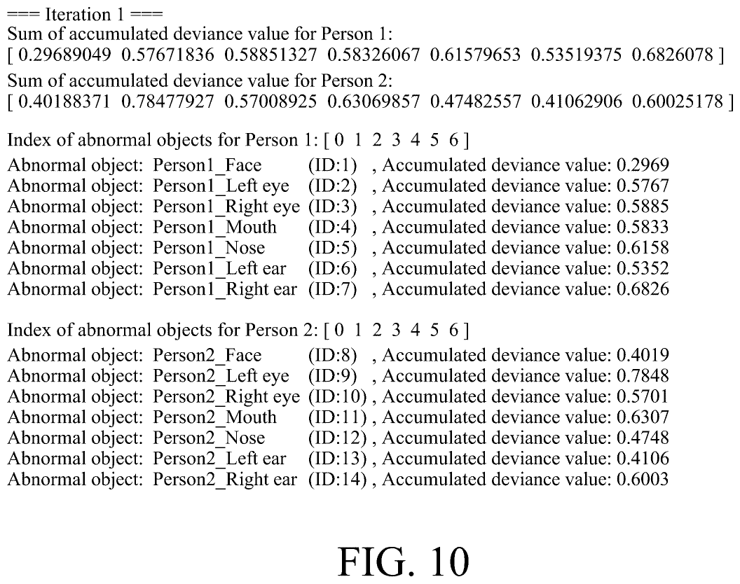

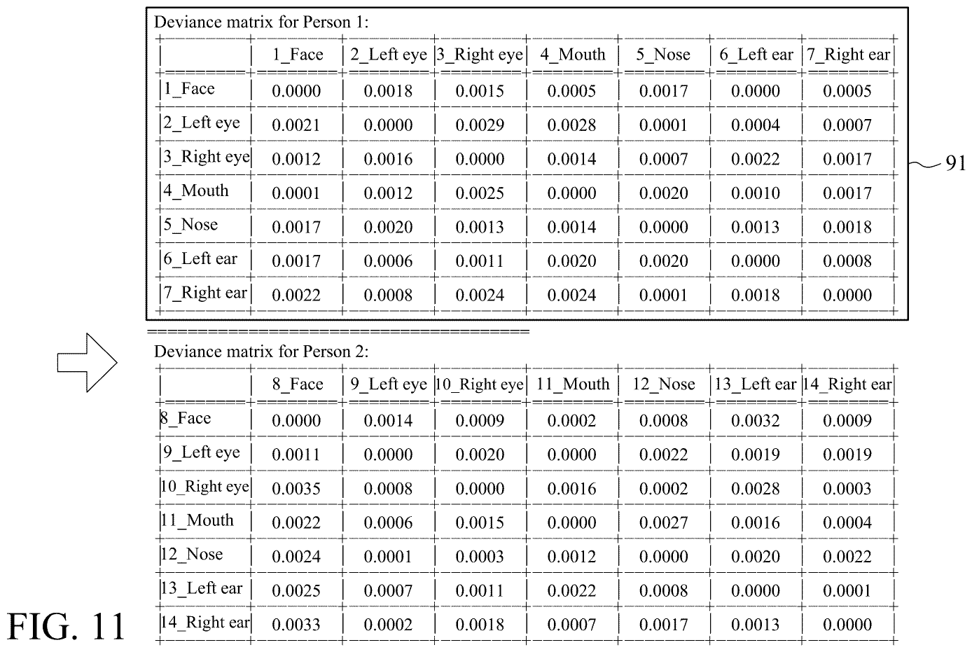

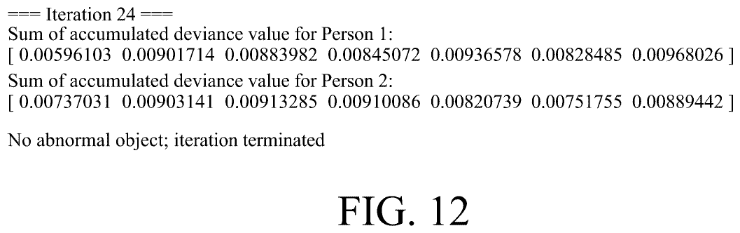

FIGS. 9 to 12 illustrates one example of a number of iterations of the swapping operations. In the example of FIGS. 9 to 12, 24 iterations are implemented before the convergence state is achieved. As such, the method for grouping facial feature objects is completed.

It is noted that in addition to being used in the DMS for identifying the driver, the method may have other applications. For example, the method may be used in images of a police lineup where a number of suspects stand side-by-side for identification.

According to some embodiments, the processing image may be obtained externally via a communication unit 14. The communication unit 14 is electrically connected to the processing unit 13, and may include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G) of, the fourth generation (4G) of or the fifth generation (5G) of wireless mobile telecommunications technology, or the like. As such, in some embodiments where the processing image is obtained externally, the image capturing unit 12 may be omitted.

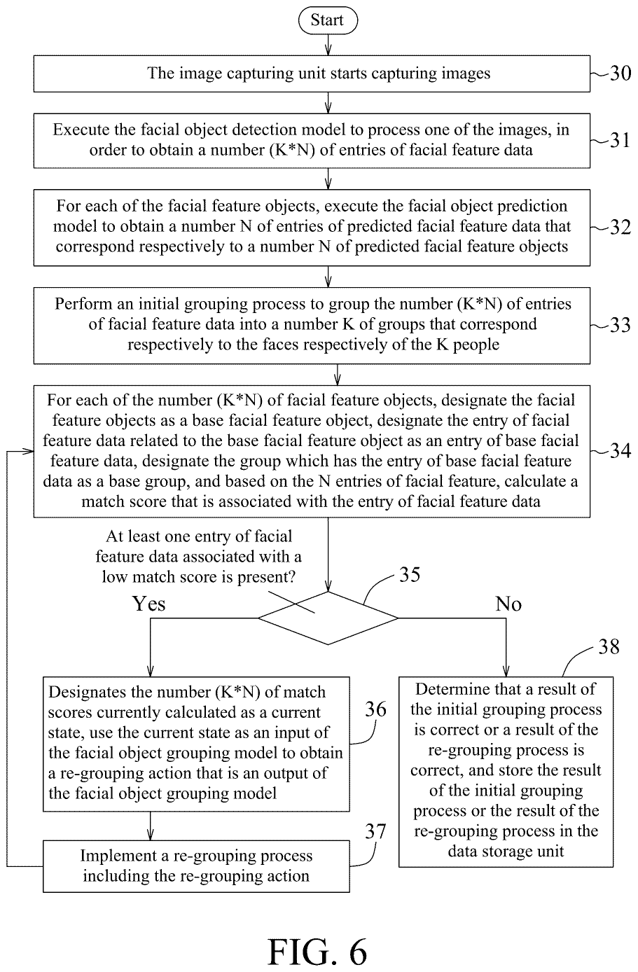

FIG. 6 is a flow chart illustrating steps of a method for grouping facial feature objects according to one embodiment of the disclosure. In the embodiment of FIG. 6, the method is implemented using the system of FIG. 1, and the data storage unit 11 of the electronic device 1 further stores a facial object grouping model therein.

In the embodiment of FIG. 6, the facial object grouping model may be embodied using a reinforcement learning (RL) network, such as a deep Q learning network (DQN) that uses the Bellman equation for implementing the operations as described below.

In step 31, the processing unit 13 executes the facial object detection model to process the processing image, in order to obtain a number (K*N) of entries of facial feature data. It is noted that in this embodiment, the processing image also contains the number K of people.

In step 32, for each of the facial feature objects (i.e., each of the number (N*K) of facial feature objects), the processing unit 13 designates the facial feature object as a to-be-predicted object, and designates a corresponding entry of facial feature data that corresponds to the to-be-predicted object as an entry of to-be-predicted facial feature data. Then, based on the entry of to-be-predicted facial feature data, the processing unit 13 utilizes the facial object prediction model to obtain a number N of entries of predicted facial feature data that correspond respectively to a number N of predicted facial feature objects which are predicted to belong to the same person (the to-be-predicted person). That is, a total of (K*N*N) entries of predicted facial feature data are obtained.

In step 33, the processing unit 13 performs an initial grouping process to group the number (K*N) of entries of facial feature data, which correspond respectively to the number (K*N) of facial feature objects from the K people, into a number K of groups that correspond respectively to the faces respectively of the K people. It should be noted that the number (K*N) of entries of facial feature data are obtained by the facial object detection model in step 31.

In step 34, the processing unit 13 designates, for each of the number (K*N) of facial feature objects, the facial feature object as a base facial feature object i, designates the entry of facial feature data related to the base facial feature object i as an entry of base facial feature data, and designates the group which has the entry of base facial feature data as a base group. Then, based on the N entries of facial feature data that are included in the base group and the N entries of predicted facial feature data that are obtained based on the entries of base facial feature data in step 22, the processing unit 13 calculates a match score that is associated with the entry of facial feature data and that indicates a probability of the entry of base facial feature data being correctly grouped.

In step 35, the processing unit 13 determines whether at least one entry of facial feature data associated with a low match score is present. Specifically, a low match score may be defined as a match score that is smaller than a predetermined threshold score. In the case where it is determined that at least one entry of facial feature data associated with a low match score is present, the flow proceeds to step 36. Otherwise, in the case where no entry of facial feature data associated with a low match score is present, the flow proceeds to step 38.

It is noted that the operations of steps 31 to 35 are similar to those of steps 21 to 25 in FIG. 2, respectively, and details thereof are omitted herein for the sake of brevity.

In step 36, the processing unit 13 designates the number (K*N) of match scores currently calculated in step 34 as a current state, uses the current state as an input of the facial object grouping model to obtain a re-grouping action that is an output of the facial object grouping model. In the embodiment of FIG. 6, the re-grouping action includes identifying two entries of to-be-swapped facial feature data, and swapping the two entries of to-be-swapped facial feature data. It is noted that in other embodiments, other suitable re-grouping actions may be employed.

In step 37, the processing unit 13 implements a re-grouping process including the re-grouping action. Specifically, the re-grouping action includes adjusting multiple entries of facial feature data that belongs to a to-be-swapped feature type. In this example, the processing unit 13 swaps the two entries of to-be-swapped facial feature data that belongs to a same to-be-swapped feature type in a manner similar to that as described in step 26, so as to obtain a number K of adjusted groups.

After the re-group action is completed, the flow goes back to step 34 to process the number (K*N) of facial feature objects based on a result of the re-grouping process, and to obtain a number (K*N) of match scores. Then, in step 35, the processing unit 13 determines whether at least one entry of facial feature data associated with a low match score is present. In the case where at least one entry of facial feature data associated with a low match score is still present, the flow proceeds to step 36 for obtaining another re-grouping action, which is also known as an iteration to reduce the number of low match scores.

In step 38, the processing unit 13 determines that a result of the initial grouping process is correct or a result of the re-grouping action is correct, and stores the result of the initial grouping process or the result of the re-grouping action into the data storage unit 11. Typically, a number of iterations are implemented before the convergence state is achieved.

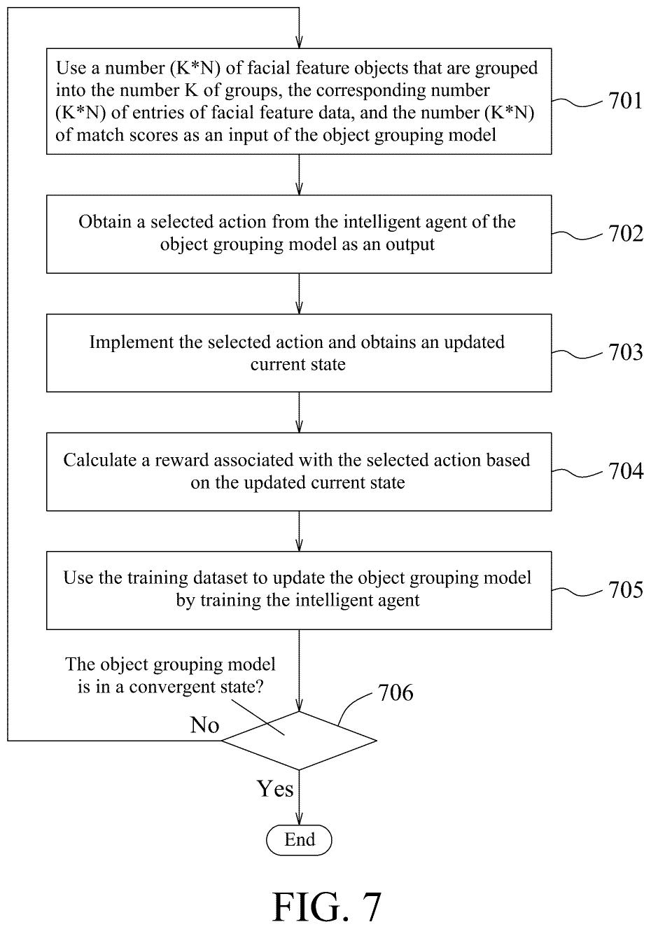

FIG. 7 is a flow chart illustrating steps of a training process that is used to train the facial object grouping model according to one embodiment of the disclosure. In the embodiment of FIG. 7, the training process is implemented using the system of FIG. 1. Generally, the training process is implemented such that the facial object grouping model is configured to train an intelligent agent (e.g., a DQN agent) that perceives an environment, and, based on the current state, to perform an action that is considered optimal via a reward mechanism.

In step 701, the processing unit 13 uses a number (K*N) of facial feature objects that are grouped into the number K of groups, the corresponding number (K*N) of entries of facial feature data, and the number (K*N) of match scores as an input of the facial object grouping model. The input in step 701 serves as the current state for the intelligent agent.

In step 702, the processing unit 13 executing the facial object grouping model obtains a selected action from the intelligent agent as an output. Specifically, the selected action may be an action related to two entries of facial feature data in two different groups among the number K of groups, such as a swapping action.

In step 703, the processing unit 13 implements the selected action obtained in step 702, and obtains an updated current state. Specifically, the processing unit 13 swaps the two entries of facial feature data in two different groups, and obtains a result of the swapping action as the updated current state.

In step 704, the processing unit 13 calculates a reward associated with the selected action based on the updated current state. Specifically, the processing unit 13 calculates a number (K*N) of updated match scores based on the updated current state, and compares a summation of the number (K*N) of match scores with a summation of the number (K*N) of updated match scores. Generally, the reward is positively related to a difference between the summation of the number (K*N) of match scores and the summation of the number (K*N) of updated match scores. For example, in the case where the summation of the number (K*N) of updated match scores is lower than the summation of the number (K*N) of match scores, it may be derived that the selected action has improved the current state, and therefore the reward is a positive value to “reward” the intelligent agent. On the other hand, in the case where the summation of the number (K*N) of updated match scores is higher than the summation of the number (K*N) of match scores, it may be derived that the selected action has made the updated current state worse than the current state, and therefore the reward is a negative value to “punish” the intelligent agent. Then, the processing unit 13 stores the current state, the selected action, the updated current state and the reward in a database pool as an entry of training data, so as to construct a training dataset that contains a plurality of entries of training data.

In step 705, the processing unit 13 uses the training dataset to update the facial object grouping model by training the intelligent agent.

In step 706, the processing unit 13 determines whether the facial object grouping model is in a convergent state. Specifically, the processing unit 13 may determine whether the reward contained in a latest one of entries of training data has an absolute value that is lower than a threshold. In the case where the facial object grouping model has not been in the convergent state, the flow goes back to step 701. Otherwise, the training of the facial object grouping model is completed, and method is terminated.

In some embodiments, as the method of FIG. 6 is being implemented, the relevant data is also stored in the database pool as an entry of training data, so as to expand the training dataset.

In some embodiments, the methods as described in the embodiments of FIGS. 2 and 6 may be implemented on a vehicle that is equipped with an in-vehicle monitoring system. The in-vehicle monitoring system includes a DMS, an occupant monitoring system (OMS) that includes camera components for capturing images of the passengers in the vehicle, and an alert unit that is connected to the processing unit 13. The DMS is configured to detect whether a driver is in a distracted state or in a fatigued state, and controls the alert unit to output an alert (e.g., flashing lights, an audio warning, etc.) to the driver.

During use, in addition to implementing the above operations, the DMS also stores the facial object detection model and the facial object prediction model therein, and is also configured to implement the method of FIG. 2 continuously. Specifically, after calculating the match scores associated with the face of the driver, the processing unit 13 determines whether at least one of the match scores is lower than a threshold. In the case where at least one of the match scores is lower than the threshold, the processing unit 13 may determine that the DMS is not correctly detecting the face of the driver, and controls the alert unit to stop outputting the alert. That is to say, the DMS will only control the alert unit to output the alert when both the fact that the DMS is correctly identifying the face of the driver and the fact that the driver is in the distracted state or the fatigued state.

It is noted that during processing subsequent images, in the case where it is determined that none of the match scores is lower than the threshold, the processing unit 13 may enable the alert unit to output the alert again.

According to some embodiments, there is a method that is to be implemented by an in-vehicle monitoring system installed in a vehicle with a number K of people. The in-vehicle monitoring system includes a processing unit, an in-vehicle camera that is for capturing images of the passengers in the vehicle, a non-transitory data storage medium that stores a grouping dataset therein, and an alert unit that is connected to the processing unit. The grouping dataset includes a number (K*N) of entries of facial feature data that correspond respectively to the number (K*N) of facial feature objects and that are grouped into the number K of groups. The method includes the following steps of:
A) while the vehicle is being driven, executing the facial object detection model to process an image captured by the in-vehicle camera to obtain a number (K*N) of entries of facial feature data, each of the number (K*N) of entries of facial feature data being associated with one of the facial feature objects included in one of the number K of faces;
B) designating, for each of the number (K*N) of facial feature objects, the facial feature object as a to-be-predicted object that is to be associated with a to-be-predicted person, designating a corresponding entry of facial feature data that corresponds to the to-be-predicted object as an entry of to-be-predicted facial feature data, and utilizing, based on the entry of to-be-predicted facial feature data, the facial object prediction model to obtain a number N of entries of predicted facial feature data that correspond respectively to a number N of predicted facial feature objects which are predicted to belong to the to-be-predicted person;
C) using the grouping dataset to group the number (K*N) of entries of facial feature data, which correspond respectively to the number (K*N) of facial feature objects from the K people, into a number K of groups that correspond respectively to the faces respectively of the K people;
D) designating, for each of the number (K*N) of facial feature objects, the facial feature object as a base facial feature object, designating the entry of facial feature data associated with the base facial feature object as an entry of base facial feature data, designating the group in which the entry of base facial feature data is grouped as a base group, and calculating a match score that is associated with the entry of facial feature data and that indicates a probability of the entry of base facial feature data being correctly grouped, which results in a number (K*N) of match scores; and
E) in the case where one of the number (K*N) of match scores is lower than a predetermined threshold, disabling the alert unit from outputting an alert.

It is noted that in some embodiments, the method may be implemented with some of the grouping dataset that are pre-stored in the data storage unit. For example, data related to the face of the driver or frequent passengers (e.g., the family members of the driver) may be pre-stored. In such cases, the operations of step C) may be simplified or omitted.

To sum up, embodiments of the disclosure provide a method and system for grouping facial feature objects. In the method, the system first performs an initial grouping process on a processing image containing K people to obtain a number K of groups each having N facial feature objects. Then, the system calculates a number of deviance values among the number (K*N) of facial feature objects, and uses the deviance values to determine the number (K*N) of match scores. In the case where at least one of the match scores is lower than a threshold, the system implements a re-grouping process to adjust some of the K groups, and, when necessary, reiterates the re-grouping process until it is determined that a result of the initial grouping process is correct or a result of the re-grouping process is correct.

Using the method and system as described above, the deficiency of some conventional applications (e.g., DMS) such as false alarms due to incorrectly identifying the the driver may be remedied, even when the image used in the method is a 2D image.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for grouping facial feature objects in a two-dimensional image, the image containing a number K of faces associated with a number K of people, respectively, each of the faces containing a number N of facial feature objects, resulting in a number (K*N) of facial feature objects, the method being implemented using an electronic device that includes a data storage unit and a processing unit, the data storage unit storing a facial object detection model and a facial object prediction model therein, the method comprising:
A) executing the facial object detection model to process the image to obtain a number (K*N) of entries of facial feature data, each of the entries of facial feature data being associated with one of the facial feature objects included in one of the faces and including a label value indicating the feature type of the associated facial feature object in the image;
B) designating, for each of the number (K*N) of facial feature objects, the facial feature object as a to-be-predicted object that is to be associated with a to-be-predicted person, designating the corresponding entry of facial feature data that corresponds to the to-be-predicted object as an entry of to-be-predicted facial feature data, and utilizing, based on the entry of to-be-predicted facial feature data, the facial object prediction model to obtain a number N of entries of predicted facial feature data that correspond respectively to a number N of predicted facial feature objects which are predicted to belong to the to-be-predicted person;
C) performing an initial grouping process to group the number (K*N) of entries of facial feature data, which correspond respectively to the number (K*N) of facial feature objects from the K people, into a number K of groups that correspond respectively to the faces of the K people;
D) designating, for each of the number (K*N) of facial feature objects, the facial feature object as a base facial feature object, designating the respective entry of facial feature data associated with the base facial feature object as an entry of base facial feature data, designating one of the K groups in which the entry of base facial feature data is grouped as a base group, and calculating a match score that is associated with the respective entry of facial feature data and that indicates a probability of the entry of base facial feature data being correctly grouped, which results in a number (K*N) of match scores; and
E) designating one of candidate entries of facial feature data that is associated with a lowest match score as an entry of target facial feature data, designating one of the facial feature objects corresponding to the entry of target facial feature data as a to-be-adjusted facial feature object, and implementing a re-grouping process with respect to the entry of target facial feature data, so as to obtain a number K of adjusted groups.

2. The method as claimed in claim 1, each of the number N of facial feature objects contained in each of the faces having a unique feature type, wherein step C) includes the sub-steps of:
C-1) selecting one of the N unique feature types as a reference type;
C-2) selecting, from among the number (K*N) of facial feature objects, a number K of facial feature objects with the reference type as a number K of reference objects, and assigning a number K of entries of facial feature data related to the number K of reference objects respectively to the number K of groups;
C-3) selecting another one of the N unique feature types as another reference type;
C-4) selecting, from among remaining facial feature objects, a number K of facial feature objects with the another reference type as a number K of reference objects, and assigning the number K of entries of facial feature data related to the number K of reference objects respectively to the number K of groups; and
repeating sub-steps C-3) and C-4) until all the number (K*N) of entries of facial feature data have been grouped.

3. The method as claimed in claim 2, wherein:
step A) includes associating each of the entries of facial feature data with at least two dimensions of the corresponding facial feature object in the image calculated by the facial object detection model; and
step B) includes associating each of the number N of predicted facial feature objects with at least an predicted area of the corresponding facial feature object in the image calculated by the facial object prediction model.

4. The method as claimed in claim 3, wherein step D) includes:
D-1) calculating, for each of the entries of facial feature data included in the base group, a deviance value based on the real area of the corresponding facial feature object obtained from the at least two dimensions and the predicted area of the corresponding facial feature object obtained from a corresponding one of the entries of predicted facial feature data in the base group that includes the base facial feature object, resulting in a number N of the deviance values; and
D-2) calculating the match score for the entry of facial feature data using the number N of the deviance values.

5. The method as claimed in claim 4, wherein sub-step D-1) includes calculating the deviance value using a following formula:
$${D}_{ij} = \vert \frac{{O}_{ij}^{base}}{{O}_{j}^{real}} - 1 \vert ,$$
where Dᵢⱼ represents the deviance value, Oᵢⱼ^{base} represents the predicted area of the corresponding facial feature object j, and Oⱼ^{real} represents the real area of the corresponding facial feature object j.

6. The method as claimed in claim 1, further comprising, prior to step E), the steps of:
F) determining whether at least one of the entries of facial feature data associated with a low match score is present;
performing step E) in a case where it is determined that the at least one of the entries of facial feature data associated with the low match score is present, and repeating step F); and
storing one of a result of the initial grouping process and a result of the re-grouping process in a case where it is determined that none of the entries of facial feature data associated with the low match score that is smaller than a predetermined threshold score is present.

7. The method as claimed in claim 6, wherein step E) includes:
E-1) identifying the entry of target facial feature data with the lowest match score and the to-be-adjusted facial feature object corresponding to the identified entry of target facial feature data;
E-2) accessing the entry of target facial feature data to determine the label value indicating the unique feature type of the to-be-adjusted facial feature object, and designating, based on the label value, the unique feature type of the to-be-adjusted facial feature object as a to-be-swapped feature type;
E-3) selecting, from among the candidate entries of facial feature data except for the entry of target facial feature data, an entry of to-be-swapped facial feature data that has a lowest match score and a label value identical to the label value of the to-be-swapped feature type; and
E-4) swapping the entry of target facial feature data and the entry of to-be-swapped facial feature data.

8. A method for grouping facial feature objects in a two-dimensional image, the image containing a number K of faces associated with a number K of people, respectively, each of the faces containing a number N of facial feature objects, resulting in a number (K*N) of facial feature objects, the method being implemented using an electronic device that includes a data storage unit and a processing unit, the data storage unit storing a facial object detection model, a facial object prediction model and a facial object grouping model therein, the method comprising:
A) executing the facial object detection model to process the image to obtain a number (K*N) of entries of facial feature data, each of the entries of facial feature data being associated with one of the facial feature objects included in one of the number K of faces;
B) designating, for each of the number (K*N) of facial feature objects, the facial feature object as a to-be-predicted object that is to be associated with a to-be-predicted person, designating the corresponding entry of facial feature data that corresponds to the to-be-predicted object as an entry of to-be-predicted facial feature data, and utilizing, based on the entry of to-be-predicted facial feature data, the facial object prediction model to obtain a number N of entries of predicted facial feature data that correspond respectively to a number N of predicted facial feature objects which are predicted to belong to the to-be-predicted person;
C) performing an initial grouping process to group the number (K*N) of entries of facial feature data, which correspond respectively to the number (K*N) of facial feature objects from the K people, into a number K of groups that correspond respectively to the K faces respectively of the K people;
D) designating, for each of the number (K*N) of facial feature objects, the facial feature object as a base facial feature object, designating the respective entry of facial feature data associated with the base facial feature object as an entry of base facial feature data, designating one of the K groups in which the entry of base facial feature data is grouped as a base group, and calculating a match score that is associated with the respective entry of facial feature data and that indicates a probability of the entry of base facial feature data being correctly grouped, which results in a number (K*N) of match scores;
E) designating the number (K*N) of match scores currently calculated as a current state, and using the current state as an input of the facial object grouping model to obtain a re-grouping action that is an output of the facial object grouping model, the re-grouping action including adjusting multiple entries of facial feature data that belongs to a to-be-swapped feature type; and
F) implementing a re-grouping process based on the re-grouping action, so as to obtain a number K of adjusted groups.

9. The method as claimed in claim 8, further comprising, prior to step E):
i) using the number (K*N) of facial feature objects that are grouped into the number K of groups, a number (K*N) of corresponding entries of facial feature data, and a number (K*N) of corresponding match scores as an input of the facial object grouping model;
ii) executing the facial object grouping model to obtain a selected action as an output, the selected action being an action related to two of the entries of facial feature data in two different groups among the number K of groups;
iii) implementing the selected action and obtaining an updated current state;
iv) calculating a reward associated with the selected action, and storing the current state, the selected action, the updated current state and the reward in a database pool as an entry of training data, so as to construct a training dataset that contains a plurality of entries of training data;
v) using the training dataset to update the facial object grouping model; and
repeating steps i) to v) until the facial object grouping model is in a convergent state.

10. The method as claimed in claim 9, wherein step iii) includes:
calculating a number (K*N) of updated match scores based on the updated current state;
comparing a summation of the number (K*N) of match scores with a summation of the number (K*N) of updated match scores;
calculating the reward to be positively related to a difference between the summation of the number (K*N) of match scores and the summation of the number (K*N) of updated match scores.

11. The method as claimed in claim 8, each of the number N of facial feature objects contained in each of the faces having a unique feature type, wherein step C) includes the sub-steps of:
C-1) selecting one of the N unique feature types as a reference type;
C-2) selecting, from among the number (K*N) of facial feature objects, a number K of facial feature objects with the reference type as a number K of reference objects, and assigning a number K of entries of facial feature data related to the number K of reference objects respectively to the number K of groups;
C-3) selecting another one of the N unique feature types as another reference type;
C-4) selecting, from among remaining facial feature objects, a number K of facial feature objects with said another reference type as a number K of reference objects, and assigning the number K of entries of facial feature data related to the number K of reference objects respectively to the number K of groups; and
repeating sub-steps C-3) and C-4) until all of the number (K*N) of entries of facial feature data have been grouped.

12. The method as claimed in claim 11, wherein:
step A) includes associating each of the entries of facial feature data with at least two dimensions of the corresponding facial feature object in the image calculated by the facial object detection model; and
step B) includes associating each of the number N of predicted facial feature objects with at least an predicted area of an corresponding facial feature object in the image calculated by the facial object prediction model.

13. The method as claimed in claim 12, wherein step D) includes:
D-1) calculating, for each of the entries of facial feature data included in the base group, a deviance value based on the real area of the corresponding facial feature object obtained from the dimensions and the predicted area of the corresponding facial feature object obtained from a corresponding one of the entries of predicted facial feature data in the base group that includes the base facial feature object, resulting in a number N of the deviance values; and
D-2) calculate the match score for the entry of facial feature data using the number N of the deviance values.

14. The method as claimed in claim 13, wherein sub-step D-1) includes calculating the deviance value using a following formula:
$${D}_{ij} = \vert \frac{{O}_{ij}^{base}}{{O}_{j}^{real}} - 1 \vert ,$$
where Dᵢⱼ represents the deviance value, Oᵢⱼ^{base} represents the predicted area of the corresponding facial feature object j, and Oⱼ^{real} represents the real area of the corresponding facial feature object j.

15. The method as claimed in claim 1, further comprising, prior to step E), the steps of:
G) calculating the match score and determining whether at least one of the entries of facial feature data associated with a low match score is present;
performing step E) in a case where it is determined that the at least one of the entries of facial feature data associated with the low match score is present, and subsequently repeating step D); and
storing one of a result of the initial grouping process and a result of the re-grouping process in a case where it is determined that none of the entries of facial feature data associated with a low match score that is smaller than a predetermined threshold score is present.

16. A method for operating an in-vehicle monitoring system, the in-vehicle monitoring system being installed in a vehicle with a number K of people, the in-vehicle monitoring system including an in-vehicle camera that is for capturing images of passengers in the vehicle, a non-transitory data storage medium that stores a facial object detection model, a facial object prediction model and a grouping dataset therein, and an alert unit that is connected to a processing unit, the grouping dataset including a number (K*N) of entries of facial feature data that correspond respectively to a number (K*N) of facial feature objects and that are grouped into a number K of groups, the method comprising the following steps of:
A) while the vehicle is being driven, executing the facial object detection model to process an image captured by the in-vehicle camera to obtain the number (K*N) of entries of facial feature data, each of the number (K*N) of entries of facial feature data being associated with one of the facial feature objects included in one of a number K of faces respectively of the people;
B) designating, for each of the number (K*N) of facial feature objects, the facial feature object as a to-be-predicted object that is to be associated with a to-be-predicted person, designating the corresponding entry of facial feature data that corresponds to the to-be-predicted object as an entry of to-be-predicted facial feature data, and utilizing, based on the entry of to-be-predicted facial feature data, the facial object prediction model to obtain a number N of entries of predicted facial feature data that correspond respectively to a number N of predicted facial feature objects which are predicted to belong to the to-be-predicted person, the number (K*N) of entries of facial feature data being grouped into a number K of groups that correspond respectively to the faces respectively of the K people;
C) designating, for each of the number (K*N) of facial feature objects, the facial feature object as a base facial feature object, designating the respective entry of facial feature data associated with the base facial feature object as an entry of base facial feature data, designating one of the K groups in which the entry of base facial feature data is grouped as a base group, and calculating a match score that is associated with the respective entry of facial feature data and that indicates a probability of the entry of base facial feature data being correctly grouped, which results in a number (K*N) of match scores; and
D) in a case where one of the number (K*N) of match scores is lower than a predetermined threshold, disabling the alert unit from outputting an alert.
